(19) United States
(12) Patent Application Publication
(10) Pub. No.: US 2025/0223860 A1
(43) Pub. Date: Jul. 10, 2025

(54) SYSTEM AND METHOD FOR AUTOMATICALLY OPENING A WINDOW OF A VEHICLE

(71) Applicant: AWOS Technologies Inc., Pointe-Claire (CA)

(72) Inventors: Shawn-Patrick Percher, Dollard-des-Ormeaux (CA); Michael Percher, Pointe-Claire (CA); Mario Verdi, Mission, TX (US); Andrea Alessandro Storelli, Pierrefonds (CA)

(21) Appl. No.: 18/842,892

(22) PCT Filed: Mar. 1, 2023
(86) PCT No.: PCT/CA2023/050263

§ 371 Date: Aug. 30, 2024

Related U.S. Application Data
(60) Provisional application No. 63/315,862, filed on Mar. 2, 2022.

(51) Int. Cl. E05F 15/72; E05F 15/695

(52) U.S. Cl. CPC E05F 15/72; E05F 15/695; E05Y 2400/446; E05Y 2400/447; E05Y 2400/449; E05Y 2900/55

(57) ABSTRACT

System and method for triggering the opening of a passenger vehicle's electric side windows and/or sunroof window in case of unexpected events such as, but not limited to submersion, collision, rollover, collisions involving rollovers, fire, as well as certain ranges of oxides and volatile organic compounds and/or other harmful gases present within the vehicle; and to give drivers and passengers the opportunity to exit the vehicle in such situations.

### CROSS-REFERENCE TO RELATED APPLICATIONS

This application claims the benefit of prior U.S. Provisional Patent Application No. 61/315,862, filed on Mar. 2, 2022, which is incorporated by reference in its entirety.

### FIELD OF THE INVENTION

The present invention relates to systems and method for automatically opening a window of a vehicle, for example due to submergence.

### BACKGROUND OF THE INVENTION

Every year, drivers and passengers of road vehicles involuntarily impact/drive into a body of water such as a lake, river, canal, sinkhole, shoreline, or collapse through thin ice, get caught in floods and flash floods. This results in thousands of people worldwide, and hundreds of people in North America alone, drowning in their passenger vehicles every year.

Known in the art, there is U.S. Pat. No. 9,206,637 (PERCHER) issued on Dec. 8, 2015. This patent discloses a system for automatically opening of a passenger vehicle's electric windows following an involuntary submersion in a body of water, or the flooding of the vehicle due to flood waters.

### SUMMARY OF THE INVENTION

According to the present invention, there is provided a method for automatically opening at least one window of a vehicle, the at least one window being operably connected to an electric system of the vehicle, the method comprising:
a) detecting an immersion condition of the vehicle,
   if the immersion condition has been detected, then detecting an upright condition of the vehicle,
      if the upright condition has been detected, then opening the at least one window;
b) detecting an accident condition of the vehicle,
   if the accident condition is detected, then detecting a stationary condition of the vehicle,
      if the stationary condition of the vehicle has been detected, then opening the at least one window.

In embodiments, the accident condition includes a rollover condition and/or a collision condition of the vehicle.

In embodiments, the method further comprises:
c) detecting a fire condition in the vehicle,
   if the fire condition has been detected, then opening the at least one window.

In embodiments, the method further comprises:
d) detecting an oxide or volatile organic compound condition in the vehicle,
   if the oxide or volatile organic compound condition has been detected, then opening the at least one window.

In embodiments, the method comprises detecting if the vehicle includes a sunroof window.

According to another aspect of the present invention, there is provided a system for automatically opening at least one window of a vehicle, the at least one window being operably connected to an electric system of the vehicle, the system comprising an electronic control module (ECM) configured to:
a) detect an immersion condition of the vehicle,
   if the immersion condition has been detected, then detect an upright condition of the vehicle,
      if the upright condition has been detected, then open the at least one window;
b) detect an accident condition of the vehicle,
   if the accident condition has been detected, then detect a stationary condition of the vehicle,
      if the stationary condition of the vehicle has been detected, then open the at least one window.

In embodiments, the system comprises a water detection module (DM) for detecting the immersion condition, the electronic control module (ECM) being connected to the water detection module (DM).

In embodiments, the system comprises at least one inertial measurement sensor (IMS) for detecting the upright condition, the electronic control module (ECM) being connected to the inertial measurement sensor (IMS).

In embodiments, the accident condition includes a rollover condition, the system comprising a rollover detection module (RDM) for detecting the rollover condition, the electronic control module (ECM) being connected to the rollover detection module (RDM).

In embodiments, the accident condition includes a collision condition, the system comprising at least one collision detection module (CDM1, CMM2) for detecting the collision condition, the electronic control module (ECM) being connected to the at least one collision detection module.

In embodiments, the system comprises a fire detection module (FDM) for detecting a fire condition in the vehicle, the electronic control module (ECM) being connected to the fire detection module (FDM), the electronic control module (ECM) being configured to open the at least one window if the fire condition is detected.

In embodiments, the system comprises an oxides and volatile organic compounds module (OVDM) for detecting an oxides or volatile organic compounds condition in the vehicle, the electronic control module (ECM) being connected to the oxides and volatile organic compounds module (OVDM), the electronic control module (ECM) being configured to open the at least one window if the oxides or volatile organic compounds condition is detected.

In embodiments, the system is configured to: trigger the opening of a passenger vehicle's electric side windows in case of unexpected events such as, but not limited to submersion, collision, rollovers, collisions involving rollovers, fire, as well as certain ranges of oxides and volatile organic compounds and/or other harmful gases present within the vehicle; and to give drivers and passengers the opportunity to exit the vehicle in such situations.

In embodiments, the system comprises an electronic control module (ECM), comprising the ECM hardware with related programming including software, firmware, priorities matrix computing and other software-related considerations, in order to manage the priority of input signals received from the vehicle and the subsequent issuance and correct timing of output commands to lower the electric side windows of a passenger vehicle.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

FIG. 1 is schematic diagram illustrating electronic components of a system, according to a preferred embodiment of the present invention.

FIG. 2 is a table illustrating a priority logic model of a method of operating a system, according to a preferred embodiment of the present invention.

### DESCRIPTION OF ILLUSTRATIVE EMBODIMENTS

The present invention is illustrated in further details by the following non-limiting examples with reference to the Figures.

In embodiments, there is provided a system 10 configured to prevent death by drowning in a vehicle, such as in a lightweight passenger vehicle. The system 10 provides a safe exit opportunity from the vehicle that is sinking in, or filling with, water by automatically lowering at least one window, but preferably all side electric windows when the vehicle is in an upright (not upside down) position. Submersion can be due to a vehicular accident in which a vehicle enters and subsequently sinks in a body of water (lake, river, canal, etc.). This can also occur if flood waters ingress into the passenger compartment of a vehicle and continue to fill it completely until there are no remaining air pockets. In both cases, pressure exerted by external water on the vehicle doors prevents them from being opened. Approximately one minute after impact with the body of water, or once the external water presses against the side windows, they too can no longer be opened. If passengers are still present in the vehicle after this time, drowning becomes inevitable.

In embodiments, the system 10 includes a water detection module (DM) 12, typically installed in the engine compartment or, alternatively, in the heaviest location in a vehicle. The DM 12 has an integrated sensor that continuously monitors the vehicle's pitch and roll axes. The sensor includes an accelerometer and/or multi-axis inclinometer, and is programmed with an acceptable range for pitch and roll angular settings that indicate an upright (not inverted) vehicle position. During a submersion, any measurements of pitch and roll that fall outside preset parameters indicates that the vehicle is not upright. The DM 12 may be hard-wired to dedicated window relays (PWCM) via waterproof, heavy 14-gauge wiring. These relays (PWCM) are installed within the vehicle doors and connected to the window lift actuators (motors) in order to lower the windows upon a command issued by the DM. Alternatively, the DM 12 can be wirelessly connected to the window relays (PWCM) or issue the command to lower the windows to the vehicle's electronic control unit (ECU) 48 via the vehicle's electronic communication buses, such as CAN Buses 22 and/or LIN Buses 20, if the window actuation function is managed by the vehicle's ECU 48.

Standard relays in vehicle doors accommodate up to 20 amperes and cannot be relied upon to lower the windows in a submersion because of the pressure exerted on the doors and windows by the external water and, as a result, the possible excess electrical stress placed on the relays. The PWCM consists of up to four single pole/single throw (SPST) relays (up to 40 ampere rating), along with heavy 14-gauge waterproof wiring. These components are not standard in passenger vehicles and are implemented in order to prevent relay overload and wire shorting upon contact with water. They enable the correct amount of electrical current required to activate the window lift actuators (motors), from a completely closed window position to a completely opened window position, upon continuous water detection by the DM. Electrical current (voltage and amperage) is conducted from the 12 V car battery through the waterproofed wires and on through the relays to power the window motors until the windows are completely opened.

As an alternative to the SPST relays, which generally require one (1) relay per electric side window, double pole/double throw (DPDT) relays could accommodate more windows using fewer relays in a lightweight passenger vehicle. Similarly, the relays can be substituted for solid state switches, which can be smaller and require fewer switches than relays. The selection and use of smaller and more efficient electronic circuit relays and/or switches form the basis of a new power window control module (NPWCM) 14. The NPWCM 14 facilitates installation in vehicles where available space within the doors may be restrictive or prohibitive.

The system 10 is configured to detect an unexpected event such as vehicle submersion, and to automatically lower a passenger vehicle's electric side windows in order to provide occupants with a means of escaping a potentially fatal situation. The system 10 build upon the teachings of U.S. Pat. No. 9,206,637 B2 (PERCHER) in order to expand its functionalities. New functional features are integrated in order to broaden the range of vehicle escape opportunities enabled by the system 10, to provide land-based vehicle escape opportunities in addition to vehicle submersion escape.

The system 10 provides an exit strategy in vehicle submersion situations, including floods, but is configured to operate in several other situations. The detection module (DM) 12 is one of multiple input signal generators used by the system. Other input signal generators include, but are not limited to: 1) the various modules described herein; 2) signals generated by other “applications, safety systems and/or sensor networks already available and functional in the vehicle and which transmit data and/or signals via a vehicle's CAN bus, LIN bus, or other electronic communication buses” (referred to as other signal inputs).

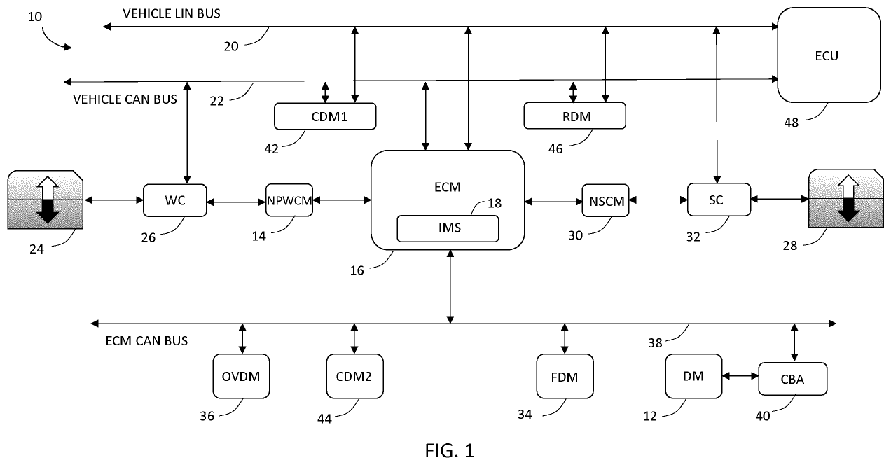

The various input signal generators transmit data and/or signals to an electronic control module (ECM) that processes priority through a logic model and algorithm(s) to trigger, through a new power window control module (NPWCM) 14, the automatic opening of a passenger vehicle's electric side windows in case of, but not limited to, vehicle submersion, fire, collision, rollover, collision with rollover, or the presence of oxides or volatile organic compounds (VOCs) or other harmful gases within the vehicle. This multi-function vehicle escape system is illustrated in FIG. 1.

The concept of lowering side electric windows allows for enhanced vehicle occupant safety when considering shatter resistant glazing, such as laminated glass and polycarbonate windows, or other shatter resistant window types, available in some passenger vehicles. While polycarbonate glazing reduces total vehicle weight, allows for novel design features such as panoramic roofs, and offers protection from high-velocity road debris, it also prevents vehicle escape and can delay occupant extraction from vehicles.

The concept of increasing the breadth of vehicle escape opportunities that the system provides, by adding new sensor detection capabilities, is anticipated to result in a significant reduction of the number of fatalities and severe injuries, such as but not limited to smoke inhalation, that occur every year when people become trapped in their road vehicles or when rescue is delayed due to the amount of time emergency responders must spend cutting doors or breaking shatter resistant windows in order to get to the trapped occupants.

Considering automotive industry initiatives to develop level 4 and level 5 autonomous vehicles, as defined by the Society of Automotive Engineers (SAE), as well as the advent of autonomous vehicle fleets owned and operated by automotive industry participants under such models as Transportation as a Service (TaaS), or shared autonomous vehicle (SAV), the concept of adding new detection capabilities to the system, as previously described, is anticipated to reduce the number of potential road fatalities and injuries that can occur due to machine error by providing occupants with a means of escaping the vehicle.

The concept of providing vehicle escape opportunities on land as well as in water may also benefit automotive industry participants, such as manufacturers, OEMs and fleet owners, as well as help to protect TaaS and SAV vehicle ownership models, by mitigating liability due to preventing fatalities.

According to a preferred embodiment of the system, there is provided an electronic control module (ECM) 16, with integrated priority logic computing, that receives input signals from, but not limited to:
integrated inertial measurement sensor (IMS) 18, including but not limited to an accelerometer and/or multi-axis inclinometer and/or inertial measurement unit (IMU) and/or gyroscope and/or a multifunctional detector module (DM);
detection modules described herein;
other input data or signals generated by applications and safety systems already available and functional in the vehicle, transmitted via a vehicle LIN bus 20, CAN bus 22 or other electronic communication buses to the vehicle's electronic control unit (ECU) 48;
additional “empty” ports for the integration of future input signals from sensor/detector networks.

According to this preferred embodiment, the electronic control module (ECM) 16 receives input data and/or signals via direct connection to: 1) an integrated inertial measurement sensor 18, including but not limited to an accelerometer and/or multi-axis inclinometer and/or inertial measurement unit (IMU) and/or gyroscope and/or a multifunctional detector module (DM) 12; 2) other modules described herein; 3) a vehicle's electronic control unit (ECU) 48 via the LIN bus 20, CAN bus 22, and/or other electronic communication buses, in order to receive “other signal inputs”.

According to this preferred embodiment, the electronic control module (ECM) 16 is directly connected to the new power window control module (NPWCM) 14 in order to lower the vehicle's electric side windows 24 via the window controls (WC) 26 upon a command signal issued by the ECM 16. Alternatively, the ECM 16 can be connected to the vehicle's electronic control unit (ECU) 48 via the vehicle's electronic communication buses, such as CAN Buses 22 and/or LIN Buses 20, without the new power window control module (NPWCM) 14 if the window actuation function is managed by the vehicle's electronic control unit (ECU) 48, in order to lower the vehicle's electric side windows 24 via the window controls (WC) 26 upon a command issued by the ECM 16.

Because all passenger vehicles have side windows 24, and considering that most operative passenger vehicles (already in use in 2022) and all new passenger vehicles that are manufactured have electric side windows, the present system 10 lowers a passenger vehicle's electric side windows 24 as the primary vehicle escape strategy. However, some passenger vehicles are equipped with sunroofs 28. Unexpectedly, sunroofs 28 may provide additional benefits when it comes to vehicle escape, and opening them is considered as a secondary vehicle escape strategy of the present system.

The sunroof 28, being located on the ceiling of a passenger vehicle, can provide more exit time to occupants in a vehicle submersion scenario, as the vehicle's ceiling would submerge after the side windows 24.

In basic configuration, where the vehicle does not have a sunroof 28, the system 10 may be preprogrammed with pitch (side-to-side rotation angle) and roll (front and/or back rotation angle) parameters that inform it on whether the vehicle is in a safe, upright (not inverted) position. The pitch parameter programmed within the system 10 may be narrow) (+30°, so as to ensure that all the electric side windows are above the water line prior to the system issuing a command to lower the side electric windows.

The sunroof 28 however, being located on a passenger vehicle's ceiling, may provide a wider pitch parameter (the vehicle can rotate further onto one of its sides, in such a way that the side windows 24 on one side of the passenger vehicle may be under the water line while the sunroof 28 is still above the water line). In land-based situations that may require vehicle escape or to ease occupant extraction from the vehicle, automatically opening the sunroof 28, in addition to the electric side windows 24, can provide occupants with an additional exit strategy or first responders with an additional access point to trapped occupants. Finally, if electric side windows 24 have become inoperative in a vehicular collision or rollover, opening the sunroof 28 represents an auxiliary exit strategy for vehicles that are equipped with them.

Sunroof controls (SC) 32 are generally managed over and communicated via a vehicle's LIN bus 20. In order to automatically open a sunroof 28 in the case of unexpected events, whether the sunroof 28 is an openable panoramic sunroof, single-pane openable sunroof, double-pane openable sunroof or folding sunroof, a new sunroof control module (NSCM) 30 that can communicate with LIN bus 20 communication protocols may be used. The NSCM 30 may be a modified NPWCM 14 that allows a sunroof 28 to be automatically opened.

According to this preferred embodiment, the electronic control module (ECM) 16 is directly connected to the new sunroof control module (NSCM) 30 in order to open the vehicle's sunroof 28 via the sunroof controls (SC) 32 upon a command signal issued by the ECM 16, if the vehicle is equipped with a sunroof 28.

According to FIG. 1, the electronic control module (ECM) 16 may be directly or indirectly connected to the passenger vehicle's various electronic communication buses, such as but not limited to the LIN bus 20 and CAN bus 22, to trigger through the new power window control module (NPWCM) 14, the opening of the side electric windows 24 of all types of passenger road vehicles in case of collision and/or rollover. In addition, if the vehicle is equipped with a sunroof 28, the ECM 16 may trigger through a new sunroof control module (NSCM) 30 the opening of the vehicle's sunroof 28.

According to FIG. 1, a fire, smoke, heat and/or combustion by-product sensor and/or detector network and/or fire detector module (FDM) 34 may be connected to the electronic control module (ECM) 16 to trigger through the new power window control module (NPWCM) 14, the opening of the side electric windows 24 of all types of passenger road vehicles in case of vehicle fire or risk of fire. In addition, if the vehicle is equipped with a sunroof 28, the ECM 16 may trigger through the new sunroof control module (NSCM) 30 the opening of the vehicle's sunroof 28. Alternatively, the ECM 16 can be connected to the vehicle's electronic control unit (ECU) 48 via connection to the vehicle's electronic communication buses, such as CAN Buses 22 and/or LIN Buses 20, without the new power window control module (NPWCM) 14 or the new sunroof control module (NSCM) 30 if the window actuation function is managed by the vehicle's electronic control unit (ECU) 48, in order to lower the vehicle's electric side windows 24 or open the sunroof 28 via the window controls (WC) 26 upon a command issued by the ECM 16 in case of fire or risk of fire.

According to FIG. 1, a sensor, detector or network of sensors and/or detectors capable of detecting oxides and volatile organic compounds (VOCs) and/or oxides and volatile organic detector module (OVDM) 36 may be connected to the electronic control module (ECM) 16 to trigger through the new power window control module (NPWCM) 14, the opening of the side electric windows 24 of all types of passenger road vehicles in case of the presence of oxides and VOCs inside the passenger compartment of the vehicle. In addition, if the vehicle is equipped with the sunroof 28, the ECM 16 may trigger through the new sunroof control module (NSCM) 30 the opening of the vehicle's sunroof 28. Alternatively, the ECM 16 can be connected to the vehicle's electronic control unit (ECU) 48 via connection to the vehicle's electronic communication buses, such as CAN Buses 22 and/or LIN Buses 20, without the new power window control module (NPWCM) 14 or the new sunroof control module (NSCM) 30 if the window actuation function is managed by the vehicle's electronic control unit (ECU) 48, in order to lower the vehicle's electric side windows 24 or sunroof 28 via the window controls (WC) 26 upon a command issued by the ECM 16 in case of the presence of oxides and VOCs inside the passenger compartment of the vehicle.

According to FIG. 1, the multifunctional detection module (DM) 12, may be connected to the electronic control module (ECM) 16, to trigger through a new power window control module (NPWCM) 14, the opening of the side electric windows 24 of all types of passenger road vehicles in case of vehicle submersion or flooding. In addition, if the vehicle is equipped with the sunroof 28, the ECM 16 may trigger through the new sunroof control module (NSCM) 30 the opening of the vehicle's sunroof 28. Alternatively, the ECM 16 can be connected to the vehicle's electronic control unit (ECU) 48 via the vehicle's electronic communication buses, such as CAN Buses 22 and/or LIN Buses 20, without the new power window control module (NPWCM) 14 or the new sunroof control module (NSCM) 30 if the window actuation function is managed by the vehicle's electronic control unit (ECU) 48, in order to lower the vehicle's electric side windows 24 or the sunroof 28 via the window controls (WC) 26 upon a command issued by the ECM 16 in case of vehicle submersion or flooding.

According to FIG. 1, applications, safety systems and/or other sensor networks already available and functional in the vehicle which transmit input data or signals via the LIN buses 20, CAN buses 22 or other electronic communication buses, may be directly or indirectly connected to the electronic control module (ECM) 16, to trigger through a new power window control module (NPWCM) 14, the opening of the side electric windows 24 of all types of passenger road vehicles when unexpected events occur, such as but not limited to fire, smoke, collision, vehicle rollover, collision with rollover, or the presence of oxides and/or volatile organic compounds (VOCs) within the vehicle. In addition, if the vehicle is equipped with the sunroof 28, the ECM 16 may trigger through the new sunroof control module (NSCM) 30 the opening of the vehicle's sunroof 28.

Surprisingly, the system is a passive safety system that transcends the initial purpose of the basic system, that of preventing death by drowning in vehicle submersions, to become a safety standard on passenger vehicles that automatically creates a vehicle escape opportunity by lowering a passenger vehicle's electric side windows when potentially life-threatening situations occur, whether on land or in water, allowing passengers to exit the vehicle or assisting emergency responders with passenger extraction from the vehicle. In addition to lowering the side electric windows, the system may open a vehicle's sunroof if the vehicle is equipped with one, as an auxiliary exit strategy.

In a preferred embodiment of the system 10 the electronic control module (ECM) 16 is located within the vehicle's passenger cabin in order to survive generally destructive events, including but not limited to collisions, rollover and fire. The multifunctional detection module (DM) 12 may be located in the engine compartment or, alternatively, in the heaviest location of a passenger vehicle when the vehicle is not front-heavy. The electronic control module (ECM) 16 becomes a “node” when directly connected, via a host processor, to the vehicle's CAN buses 22, LIN buses 20, or other electronic communication buses in order to receive input data and/or signals transmitted by applications, safety systems or sensor networks already available and functional in vehicles, in order to reduce hardware redundancy.

With the new concept, all the electric side windows of all types of road passenger vehicles will lower because of direct, full and continuous electrical current from the vehicle's 12 V battery supply, upon a signal or command issued through the new power window control module (NPWCM) 14 by the electronic control module (ECM) 16. If the vehicle is equipped with the sunroof 28, the sunroof 28 will be opened in addition to the side electric windows 24 because of full and continuous electrical current from the vehicle's 12 V battery supply, upon a command issued through the new sunroof control module (NSCM) 30 by the electronic control module (ECM) 16.

In a preferred embodiment, the various components that, together, form the overall system are treated as individual modules. A modular design advantageously facilitates the addition or removal of modules and facilitate adaptability and integration of the system 10, depending on the type of vehicle, without interfering with the overall purpose and proper function of the system.

The multi functional detection module (DM) 12 may be connected to the ECM 16 via a ECM CAN BUS 38 via CAN BUS adapter 40.

The sensor and/or detector network, or module, that detects heat, smoke, and/or combustion by-product related to vehicle fire, whether such sensor/detector networks are already available and functional in passenger vehicles or not already available and functional in passenger vehicles, is considered as the fire detection module (FDM) 34.

The sensor and/or detector network, or module, that detects oxides and volatile organic compounds, whether such sensor/detector networks are already available and functional in passenger vehicles or not already available and functional in passenger vehicles, is considered as the oxides and volatile organic compounds detection module (OVDM) 36.

Various applications, safety systems or other sensor networks already available and functional in passenger vehicles transmit input data and/or signals to the vehicle's electronic control unit (ECU) 48 via the vehicle's electronic communication buses, including but not limited to CAN buses 22 and LIN buses 20. By connecting the electronic control module (ECM) 16 to such electronic communication buses, either directly or indirectly, in order to receive input data and/or signals relating to passenger vehicle collision, the electronic control unit (ECU) 48 and electronic communication buses, such as CAN buses and/or LIN buses, are considered as one (1) of the input components, but not all input components, forming the collision detection module (CDM1) 42.

Alternatively, if it is not possible to connect the electronic control module (ECM) 16 to at least one of the passenger vehicle's electronic communication buses, CAN buses and/or LIN buses in order to receive input data and/or signals relating to vehicle collision, a network of sensor and/or detectors that detect passenger vehicle collision is developed and considered as one (1) of the input components, but not all input components, forming an alternate collision detection module (CDM2) 44.

In addition to other signal inputs received by the electronic control module (ECM) 16 from the passenger vehicle's electronic control unit (ECU) 48 via the vehicle's electronic communication buses, such as CAN buses and/or LIN buses, the modules of the system 10 also form components of the collision detection modules for both CDM1 42 and CDM2 44. Features and advantages of this subject matter will become more apparent in light of the descriptions covered in “Collision Detection Modules (CDM1 and CDM2)”.

Various applications, safety systems and/or sensor networks available and functional in passenger vehicles generate input data and/or signals related to vehicle rollover, such as but not limited to crash event duration, vehicle roll angle and airbag deployment, and communicate such data and/or signals via various electronic communication buses, CAN buses or LIN buses. By directly or indirectly connecting the electronic control module (ECM) to the various electronic communication buses, CAN buses and/or LIN buses, the ECM receives such input data and/or signals relating to vehicle rollover. Therefore, the electronic communication buses are considered as one (1) of the input components, but not all input components, forming the rollover detection module (RDM) 46.

In addition, the integrated inertial measurement sensor 18 can detect that a vehicle rollover is initiated, and can equally detect when the rollover is finished, or that the vehicle has become stationary. The inertial measurement sensor 18 can include but not be limited to an accelerometer and/or a multi-axis inclinometer and/or inertial measurement unit (IMU) and/or a gyroscope and/or a multifunctional detection module (DM) 12. It can be integrated within the electronic control module (ECM) 16, or directly connected to but external to the ECM 16. As an illustrative example, such sensors can measure linear force and orientation of the vehicle using at least three vector planes. One such vector plane can be programmed to have a gravity vector (G) that points toward the gravitational center of the Earth. During a rollover, the gravity vector will continue to point toward the Earth's gravitational center, while the coordinates describing other vector planes will vary erratically as the vehicle rotates and/or moves. When the vehicle becomes stationary, the three-dimensional coordinates describing the vector planes will become stable and not vary. This can be used to detect that the passenger vehicle has become stationary (not rolling over). Therefore, the beginning of the rollover (vehicle rotation or spinning) and end (stationary phase) can be detected, and this input data is transmitted to the ECM 16.

The rollover detection module (RDM) 46 is therefore comprised of, but not limited to, an inertial measurement sensor that can include an accelerometer and/or multi-axis inclinometer and/or IMU and/or gyroscope and/or the multi functional detection module (DM), as well as input data and/or signals from the passenger vehicle's electronic control unit (ECU) 48, electronic communication buses, CAN buses and/or LIN buses. Additional sensor and/or detector networks already available and functional in the vehicle, or not already available and functional in the vehicle, can be integrated to the rollover detection module to improve accuracy and functionality.

### Collision Detection Modules (CDM1 and CDM2)

As stated, various applications, safety systems and/or other sensor networks available and functional in passenger vehicles generate usable input data and/or signals that are transmitted via various electronic communication buses, CAN buses 22 or LIN buses 20 within the vehicle.

As an illustrative example, it is also stated that an event data recorder (EDR), similar to an accident data recorder (ADR) and sometimes referred to informally as an automotive black box, is a device installed in some automobiles to record information related to traffic collisions.

Specifically, event data recorders (EDR) receive and record key data that can be used to identify that a collision and/or rollover has occurred:
Forward and lateral crash force;
Crash event duration;
Indicated vehicle speed;
Accelerator position;
Engine rpm;
Brake application and antilock brake activation;
Steering wheel angle;
Stability control engagement;
Vehicle roll angle, in case of a rollover;
Number of times the vehicle has been started;
Driver and front-passenger safety belt engagement, and pretensioner or force limiter engagement;
Air bag deployment/speed/and faults for all air bags;
Front seat positions;
Occupant size;
Number of crashes (one or more impacts during the final crash event).

Considering the cost-reduction nature of the automotive industry, avoiding or reducing hardware redundancy is a chief objective of the new concept. In light of the fact that other signal inputs from the vehicle are already generated and can be usable, by accessing on-board diagnostics (OBD), the present system 10 may access such data, via direct or indirect connection of the electronic control module (ECM) 16 to the passenger vehicle's electronic OBD ports, electronic control unit (ECU) 48 and/or electronic communication buses, such as CAN buses 22 and/or LIN buses 20, therefore forming part of, but not all of, the collision detection module (CDM1) 42 input data. These “other signal inputs” are transmitted to the electronic control module (ECM) 16 for priority processing.

In a preferred embodiment of the system, the collision detection module (CDM1) 42, the system avoids sensor and/or detector redundancy by direct or indirect connection of the electronic control module (ECM) 16 to the vehicle's electronic control unit (ECU) 48 via the vehicle's electronic communication buses, such as but not limited to the CAN buses 22 and/or LIN buses 20.

While some of the data that can be accessed from the vehicle's various electronic communication buses relate to pre-crash data, the system 10 may only require after-crash data that confirms that one or more collisions have occurred. In relation to vehicle collision, the electronic control module (ECM) 16 considers such data as, but not limited to, stability control engagement, absolute vehicle speed, forward and lateral crash force and crash event duration. These data represent input signals to be received by the electronic control module (ECM) 16 for priority processing in order to assess whether the vehicle's electric side windows should be lowered.

In this preferred embodiment of the collision detection module (CDM1) 42, the passenger vehicle's electronic control unit (ECU) 48 and communication buses such as CAN buses 22 and/or LIN buses 20 become the primary input signal source and/or component, but not the only source and/or component, of the collision detection module (CDM1) 42.

The system 10 may be optimized to avoid interfering with the proper functioning of applications, safety systems and other sensor networks already available and functioning in passenger vehicles, such as the mass adopted airbag system. Unexpectedly, the system creates vehicle escape or extraction opportunities following a collision, with or without airbag deployment, without impacting the proper functioning of the passenger vehicle's other, yet equally important safety systems.

It is stated that when a road vehicle is involved in an accident that requires the deployment of one or more airbags, the airbag(s) will deploy. The side airbags, commonly known as “curtain airbags”, function optimally when the corresponding side windows are closed (not lowered), thus acting as a support.

It is also stated that when a passenger vehicle is involved in a frontal accident, all front airbags (driver and the front passenger frontal airbags) will automatically deploy in or less than 1120th of a second.

In the same vein, the NHTSA stated that “ . . . when there is a moderate to severe crash, a signal is sent from the airbag system's electronic control unit to an inflator within the airbag module. An igniter in the inflator starts a chemical reaction that produces a harmless gas, which inflates the airbag within the blink of an eye-or less than 1120th of a second. Because airbags deploy very rapidly, serious or sometimes fatal injuries can occur if the driver or passenger is too close to-or comes in direct contact with-the airbag when it first begins to deploy . . . ”.

It is equally stated that airbags must never deploy when the vehicle speed is below eight (8) miles per hour, that front airbags are designed to not deploy during a side impact or during a vehicle rollover, and that side airbags will not deploy unless the force is strong enough to trigger the system.

By accessing after-crash data, as previously described, it is assumed that the airbags will have had sufficient time to deploy (inflate and deflate) during the collision. However, in order to ensure that the airbags have deployed, certain methods and additional input signals are considered for the collision detection module (CDM1) 42.

The electronic control module (ECM) 16 uses data such as, but not limited to, stability control engagement, absolute vehicle speed, forward and lateral crash force, crash event duration and number of crashes to initially confirm that one (1) or more collisions have occurred.

As stated, the integrated inertial measurement sensor 18 can generate usable data and/or signals that indicate that a passenger vehicle is stationary. Therefore, the electronic control module (ECM) 16 also considers additional data generated by the inertial measurement sensor 18 in order to determine that the vehicle is stationary (not moving and not spinning) following one or more collisions prior to issuing a command to lower the electric side windows. Features and advantages of the electronic control module (ECM) 16 will become more apparent in light of the descriptions covered in “Electronic Control Module (ECM)”.

As an added measure of safety for occupants, and to ensure that applications, safety systems and other sensor networks available and functional in the passenger vehicle have had time to perform their respective functions, prior to the system lowering any electric side window 24, a variable time delay setting is available within the EMC's priority computing logic. The time delay setting is variable, ranging from 1 to 60 seconds, so as to allow manufacturers to set a time delay that best meets the needs of a given vehicle model. In addition to the signals and methods previously described, the EMC 16 verifies whether a time delay has been set and respects the variable time delay prior to issuing a command to lower the vehicle's electric side windows.

The ECM 16 processes and determines the priority of the input signals accessed via various electronic communication buses, CAN buses 22 or LIN buses 20, data from the integrated inertial measurement sensor, and the variable time delay criterion. If all the conditions to lower the electric side windows are met, the ECM 16 issues a command to lower the side electric windows 24, by direct connection to a new power window control module (NPWCM) 14, after a collision has occurred, in order to provide a vehicle escape opportunity or to remove barriers for emergency responders, such as shatter-resistant glazing. In addition, if the vehicle is equipped with the sunroof 28, the ECM 16 may trigger through the new sunroof control module (NSCM) 30 the opening of the vehicle's sunroof 28. Alternatively, the ECM 16 issues a command to lower the side windows 24 or open the sunroof 28 by connection to the vehicle's electronic control unit (ECU) 48 via the vehicle's electronic communication buses, such as CAN Buses 22 and/or LIN Buses 20, without the new power window control module (NPWCM) 14 or the new sunroof control module (NSCM) 30, if the window actuation function is managed by the vehicle's electronic control unit (ECU) 48, after a collision has occurred.

The second embodiment of the collision detection module (CDM2) 44 is connected to the electronic control module (ECM) 16 and an input signal from CDM2 44 to the ECM 16 is the initial signal that a collision has occurred, but not the only input signal for the ECM 16 to process prior to issuing a command via the NPWCM 14 to lower the passenger vehicle's electric side windows 24 or, alternatively, via the vehicle's electronic control unit (ECU) 48 to lower the passenger vehicle's side electric windows 24 if the window actuation function is managed by the vehicle's ECU 48.

To ensure that the airbags have had sufficient time to deploy (inflate and deflate), the electronic control module (ECM) 16 accesses “other signal inputs” from the vehicle, such as absolute vehicle speed, stability control engagement, crash event duration, and number of crashes. The ECM 16 also considers input signals from the integrated inertial measurement sensor 18 to confirm when the vehicle has become stationary (not moving), signaling that the collision event has ended. Features and advantages of the electronic control module (ECM) 16 will become more apparent in light of the descriptions covered in “Electronic Control Module (ECM)”.

In addition to the signals and methods described, the EMC 16 verifies whether a variable time delay ranging from 1 to 60 seconds has been set and respects the programmed delay prior to issuing a command to lower the passenger vehicle's electric side windows 24.

If all stated conditions for lowering at least one of a passenger vehicle's electric side windows 24 are met following one or more collisions, the electronic control module (ECM) 16 issues a command to lower the side electric windows 24, by direct connection to the new power window control module (NPWCM) 14 in order to provide a vehicle escape opportunity or to render occupant extraction possible. In addition, if the vehicle is equipped with the sunroof 28, the ECM 16 may trigger through the new sunroof control module (NSCM) 30 the opening of the vehicle's sunroof 28. Alternatively, the ECM 16 issues a command to lower the side windows 24 or open the sunroof 28 by connection to the vehicle's electronic control unit (ECU) 48 via the vehicle's electronic communication buses, such as CAN Buses 22 and/or LIN Buses 20, without the new power window control module (NPWCM) 14 or the new sunroof control module (NSCM) 30, if the window actuation function is managed by the vehicle's electronic control unit (ECU) 48, after a collision has occurred.

### Rollover Detection Module (RDM) 46

It is stated that an inertial measurement sensor, comprising but not limited an accelerometer and/or multi-axis inclinometer and/or inertial measurement unit (IMU) and/or gyroscope and/or the multifunctional detection module (DM), can detect a vehicle's orientation and angular rotation rate, which is used to detect when a passenger vehicle rollover is initiated and when the said rollover comes to an end, signaling that the vehicle is in a stationary position.

The rollover detection module (RDM) 46 is comprised of, but not limited to, “other signal inputs” that are generated by applications, safety systems and/or other sensor networks already available and functional in the vehicle, which are transmitted to the vehicle's electronic control unit (ECU) 48 through the electronic communication buses, CAN buses 22 and/or LIN buses 20, as well as an integrated inertial measurement sensor, comprising but not limited an accelerometer and/or multi-axis inclinometer and/or inertial measurement unit (IMU) and/or gyroscope and/or the multifunctional detection module (DM), and data generated by it.

It is stated that fatalities due to vehicle rollover are commonly the result of a vehicle occupant being ejected through open windows during the vehicle rollover. The new concept aims to prevent ejection during a rollover by not lowering the side electric windows or opening the sunroof while vehicle rollover is occurring, and only lowering the electric side windows and opening the sunroof 28 when the vehicle is stationary, or not rolling over.

It is previously stated that the system is designed to not interfere with the proper function of other safety systems available and functional in passenger vehicles, such as airbags. Airbags, and more precisely curtain airbags, require that the corresponding electric side window be closed, or in the completely closed position, in order to function properly.

According to publicly available market data, as previously stated, airbags normally inflate within 1120th of a second and deflate within an equally short period of time. However, side airbags (curtain airbags) may remain inflated for a longer period of time during a rollover, up to ten (10) or more seconds. Some curtain airbags can remain inflated for several minutes during a rollover, to account for the time it takes for the rollover to end. This feature is not a regulatory mandate, but most curtain airbags have this function in automobiles sold as of 2018, in North America.

The electronic control module (ECM) 16 receives and/or accesses input signals from the integrated inertial measurement sensor 18 to signal that a vehicle rollover has been initiated. This sensor 18 can also inform the electronic control module (ECM) 16 when the rollover event has terminated and that the vehicle is stationary. The electronic control module (ECM) 16 may access other input signals from the vehicle's electronic control unit (ECU) 48 through the vehicle's electronic communication buses, CAN buses 22 and/or LIN buses 20, such as but not limited to stability control engagement, absolute vehicle speed, crash event duration, and vehicle roll angle, in order to validate that a rollover is in fact triggered and/or occurring.

Considering that vehicle rollover can occur following one or more collisions, or precede one or more collisions, the electronic control module (EMC) 16 receives and harmonizes the input signals from the rollover detection module (RDM) 46, collision detection module (CDM1 42 and/or CDM2 44) and the integrated inertial measurement sensor 18 in order to confirm that the initiated event has ended and that the vehicle has become stationary (not moving, spinning, or rolling over).

In addition to the signals and methods described, the EMC 16 verifies whether a variable time delay ranging from 1 to 60 seconds has been set and respects the programmed time delay prior to issuing a command to lower the passenger vehicle's electric side windows.

If all stated conditions for lowering at least one of a passenger vehicle's electric side windows are met following passenger vehicle rollover or one or more passenger vehicle collision(s) with or without rollover, the electronic control module (ECM) 16 issues a command to lower the side electric windows 24, by direct connection to a new power window control module (NPWCM) 14 in order to provide a vehicle escape opportunity or to render occupant extraction possible. In addition, if the vehicle is equipped with the sunroof 28, the ECM 16 may trigger through the new sunroof control module (NSCM) 30 the opening of the vehicle's sunroof 28. Alternatively, the ECM 16 issues a command to lower the side windows 24 or open the sunroof 28 by connection to the vehicle's electronic control unit (ECU) 48 via the vehicle's electronic communication buses, such as CAN Buses 22 and/or LIN Buses 20, without the new power window control module (NPWCM) 14 or the new sunroof control module (NSCM) 30, if the window actuation function is managed by the vehicle's electronic control unit (ECU) 48, after a rollover or collision(s) with or without rollover have occurred.

### Fire Detection Module (FDM) 34

The most common causes of vehicle fire include, but are not limited to, fuel leaks, electrical system failure, overheating engines, clogged or overworked catalytic converters, dangerous items being carried on board, smoking and driving, etc.

Electric vehicles can also pose fire risks, the source of which can include arcing, damaged or punctured battery cells, etc.

In a preferred embodiment, the fire detection module (FDM) 34 is designed to detect the presence of smoke, and/or by-products of combustion, and issue an input signal to the electronic control module (ECM) 16 for priority processing. The ECM 16 issues a command to lower the electric side windows when the situation is deemed unsafe due to smoke or fire within the passenger compartment, as well as smoke or fire outside of the passenger compartment but still within the vehicle, either in the engine compartment, trunk, near the battery cells of electric vehicles, etc. In addition, if the vehicle is equipped with the sunroof 28, the ECM 16 additionally issues a command to open the vehicle's sunroof 28.

The fire detection module (FDM) 34 includes of a network of sensors and/or detectors which detect the by-products of combustion, including but not limited to smoke, heat, particulate density and other combustible by-products.

The sensors and/or detectors forming the fire detection module (FDM) 34 can include, but are not limited to, catalytic combustion, electrochemical, infrared and/or photoionization detectors.

The electronic control module (ECM) 16 receives an input signal from the fire detection module (FDM) 34 and considers other signal inputs from the vehicle prior to issuing a command to lower the electric side windows. If the vehicle is stationary when the command has been received by the ECM 16, a command to lower the passenger vehicle's electric side windows may be issued. If the vehicle is moving, the ECM 16 will not issue a command to lower the windows until the vehicle is stationary. In addition, if the vehicle is equipped with sunroof 28, the ECM 16 may trigger the opening of the vehicle's sunroof 28. Oxides and Volatile Organic Compounds Detection Module (OVDM) 36

The oxides and volatile organic compounds (VOCs) module (OVDM) 36 is composed of sensors and/or detectors, assembled into a node, that detect ranges of oxides, volatile organic compounds and other chemicals and/or substances that are harmful to a person's health, connected directly to the electronic control module (ECM) 16. The unit is located within the vehicle's passenger compartment. If the OVDM 36 detects the presence of oxides, volatile organic compounds (VOCs) and/or harmful chemicals within the passenger compartment, an input signal is issued to the electronic control module (ECM) 16.

The electronic control module (ECM) 16 manages preprogrammed priorities prior to issuing a command to lower the side electric windows. If oxides, VOCs and/or harmful chemicals are detected within the passenger compartment, a command to lower the windows is issued through the new power window control module (NPWCM) 30. In addition, if the vehicle is equipped with sunroof 28, the ECM 16 may trigger through the new sunroof control module (NSCM) 30 the opening of the vehicle's sunroof 28. Alternatively, the ECM 16 issues a command to lower the side windows 24 or open the sunroof 28 by connection to the vehicle's electronic control unit (ECU) 48 via the vehicle's electronic communication buses, such as CAN Buses 22 and/or LIN Buses 20, without the new power window control module (NPWCM) 14 or the new sunroof control module (NSCM) 30, if the window actuation function is managed by the vehicle's electronic control unit (ECU) 48, if oxides, VOCs and/or harmful chemicals are detected within the vehicle's passenger compartment.

### Electronic Control Module (ECM) 16

Considering the analysis required for enhanced passenger vehicle occupant safety and the anticipated stringent industry requirements for the system 10, a central computing component that receives input signals from the various sensor modules of the system 10 and other signal inputs from the vehicle's electronic control unit (ECU) 48 via the vehicle's communication buses, CAN buses 22 and/or LIN buses 20, is required for managing priorities.

The ECM 16 is connected in a two-way open circuit with the components and/or modules of the system 10, or the vehicle's electronic control unit (ECU) 48 and electronic communication bus such as the ECM CAN bus 38, in order to trigger through the new power window control module (NPWCM) 14, the lowering of at least one of a passenger vehicle's electric side windows 24 of all types of passenger road vehicles when unexpected and potentially fatal water and land-based events occur. In addition, if the vehicle is equipped with sunroof 28, the ECM 16 may trigger through the new sunroof control module (NSCM) 30 the opening of the vehicle's sunroof 28. Alternatively, the ECM 16 can issue a command to lower the side windows 24 or open the sunroof 28 by connection to the vehicle's electronic control unit (ECU) 48 via the vehicle's electronic communication buses, such as CAN Buses 22 and/or LIN Buses 20, without the new power window control module (NPWCM) 14 or the new sunroof control module (NSCM) 30, if the window actuation function is managed by the vehicle's electronic control unit (ECU) 48, when unexpected and potentially fatal water and land-based events occur.

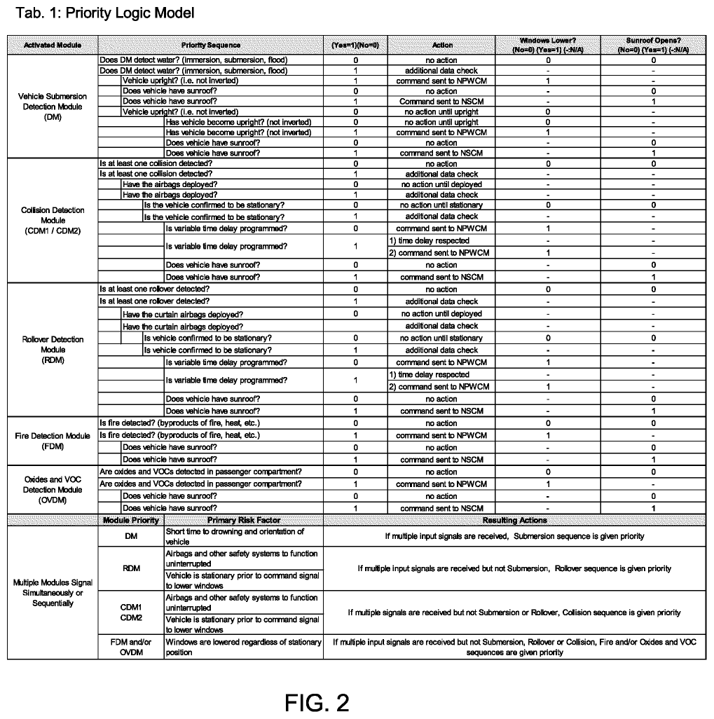

The ECM 16 harmonizes all input data and/or signals and follows a predetermined logic/priority protocol. The ECM sorts through [if/or/and] logic in order to establish the sequencing of all the unexpected events related to passenger vehicle submersion, fire, collision(s), rollover, collision(s) with rollover, and the presence of oxides and/or volatile organic compounds (VOCs) and/or harmful chemicals or substances within the passenger compartment, determines and classifies their priority and safely triggers the lowering of a passenger vehicle's electric side windows through a command issued through the new power window control module (NPWCM) 14. As a secondary vehicle escape strategy for passenger vehicles equipped with sunroofs 28, the ECM 16 may trigger through the new sunroof control module (NSCM) 30 the opening of the vehicle's sunroof 28. The command to lower the windows 24 or open the sunroof 28 may alternatively be issued to the vehicle's electronic control unit (ECU) 48 via the vehicle's electronic communication buses, such as CAN buses 22 and/or LIN buses 20, without the NPWCM 14 or NSCM 30 if the window actuation function is managed by the vehicle's electronic control unit (ECU) 48. FIG. 2 provides a non-exhaustive summary of the priority logic model employed by the system, the decision-making sequencing of each module as well as the priority when more than one event occurs simultaneously. The central computing component may be the system's 10 electronic control module (ECM) 16. Alternatively, the priority logic of the system 10 may be exported, by means of software and firmware and uploaded into the vehicle's ECU 48.

The electronic control module (ECM) 16 may also generate and manage diagnostic data, either by way of built-in self testing (BIST) or accessed by plugging a diagnostic tool into a designated outlet, in order to enable efficient system maintenance.

The electronic control module (ECM) 16 transmits with and receives data from various safety applications, safety systems and other sensor networks already available and functional in passenger vehicles via direct or indirect connection to the vehicle's electronic control unit (ECU) 48 through the vehicle's electronic communication buses, CAN buses 22 or LIN buses 20.

### Power Consumption and Modules

The mean current consumption for the system 10 is in the order of about 10 mA when the car is OFF. A power-saving option for the present system and/or individual modules, or sleep mode, is possible under certain conditions. The wake-up feature on the CAN bus 22 may be adequate to perform this action. Alternatively, detecting a person's presence via dielectric change, similar to how the multifunctional detection module operates, is possible with the integration of a sensor within the passenger compartment.

Various sensors/detectors may have different “warm up” times. These time differentials relate to the time it takes for a given sensor/detector to become completely operational. These differentials will be considered and managed by the electronic control module (ECM) 16 to ensure that modules are functional when occupants are in the vehicle.

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

1. A method for automatically opening at least one window of a vehicle, the at least one window being operably connected to an electric system of the vehicle, the method comprising:
a) detecting an immersion condition of the vehicle,
if the immersion condition has been detected, then detecting an upright condition of the vehicle,
if the upright condition has been detected, then opening the at least one window;
b) detecting a rollover condition of the vehicle,
if the immersion condition is not detected and if the rollover condition is detected simultaneously, then detecting a stationary condition of the vehicle,
if the stationary condition of the vehicle has been detected, then opening the at least one window.

2. The method of claim 1, further comprising:
c) detecting a collision condition of the vehicle,
if the immersion condition is not detected and the rollover condition is not detected and the collision condition is detected simultaneously, then detecting a stationary condition of the vehicle,
if the stationary condition of the vehicle has been detected, then opening the at least one window.

3. The method of claim 2, further comprising:
d) detecting a fire condition in the vehicle,
if the immersion condition is not detected and the rollover condition is not detected and the collision condition is not detected and the fire condition has been detected simultaneously, then opening the at least one window.

4. The method of claim 2 or 3, further comprising:
e) detecting an oxide or volatile organic compound condition in the vehicle,
if the immersion condition is not detected and the rollover condition is not detected and the collision condition is not detected and the oxide or volatile organic compound condition has been detected simultaneously, then opening the at least one window.

5. The method of claim 1, further comprising detecting if the vehicle includes a sunroof window.

6. A system for automatically opening at least one window of a vehicle, the at least one window being operably connected to an electric system of the vehicle, the system comprising:
an electronic control module (ECM) configured to:
a) detect an immersion condition of the vehicle,
if the immersion condition has been detected, then detect an upright condition of the vehicle,
if the upright condition has been detected, then open the at least one window;
b) detect a rollover condition of the vehicle,
if the immersion condition is not detected and if the rollover condition has been detected simultaneously, then detect a stationary condition of the vehicle,
if the stationary condition of the vehicle has been detected, then open the at least one window.

7. The system of claim 6, wherein the electronic control module (ECM) is further configured to:
c) detect a collision condition of the vehicle,
if the immersion condition is not detected and the rollover condition is not detected and the collision condition is detected simultaneously, then detecting a stationary condition of the vehicle,
if the stationary condition of the vehicle has been detected, then opening the at least one window.

8. The system of claim 6, wherein the electronic control module (ECM) is further configured to:
d) detect a fire condition in the vehicle,
if the immersion condition is not detected and the rollover condition is not detected and the collision condition is not detected and the fire condition has been detected simultaneously, then opening the at least one window.

9. The system of claim 7, wherein the electronic control module (ECM) is further configured to:
e) detect an oxides or volatile organic compound condition in the vehicle,
if the immersion condition is not detected and the rollover condition is not detected and the collision condition is not detected and the oxide or volatile organic compound condition has been detected simultaneously, then opening the at least one window.

10. The system of claim 6, comprising a water detection module (DM) for detecting the immersion condition, the electronic control module (ECM) being connected to the water detection module (DM).

11. The system of claim 6, comprising at least one inertial measurement sensor (IMS) for detecting the upright condition, the electronic control module (ECM) being connected to the inertial measurement sensor (IMS).

12. The system of claim 6, further comprising a rollover detection module (RDM) for detecting the rollover condition, the electronic control module (ECM) being connected to the rollover detection module (RDM).

13. The system of claim 7, further comprising at least one collision detection module for detecting the collision condition, the electronic control module (ECM) being connected to the at least one collision detection module.

14. The system of claim 8, further comprising a fire detection module (FDM) for detecting the fire condition in the vehicle, the electronic control module (ECM) being connected to the fire detection module (FDM), the electronic control module (ECM) being configured to open the at least one window if the fire condition is detected.

15. The system of claim 9, further comprising an oxides and volatile organic compounds module (OVDM) for detecting the oxides or volatile organic compounds condition in the vehicle, the electronic control module (ECM) being connected to the oxides and volatile organic compounds module (OVDM), the electronic control module (ECM) being configured to open the at least one window if the oxides or volatile organic compounds condition is detected.

16. The system of claim 6, wherein the at least one window comprises side windows.

17. The system of claim 6, wherein the at least one window comprises a sunroof window.
